(19) United States
(12) Patent Application Publication
(10) Pub. No.: US 2017/0083042 A1
(43) Pub. Date: Mar. 23, 2017

(54) SURFACE SHAPING OF DEVICE PACKAGES TO MITIGATE FRACTURES UNDER BENDING STRESS

(71) Applicant: Apple Inc., Cupertino, CA (US)

(72) Inventors: Shawn X. ARNOLD, Santa Cruz, CA (US); G. Kyle LOBISSER, Los Altos Hills, CA (US); Mark BEESLEY, Carmel Valley, CA (US)

(21) Appl. No.: 14/860,670

(22) Filed: Sep. 21, 2015

(51) Int. Cl. G06F 1/16

(52) U.S. Cl. CPC G06F 1/16

(57) ABSTRACT

This application relates to systems, methods, and apparatuses for reducing bending stresses and tension from damaging components of a computing device. A component of the computing device can be connected to a spacer that can distribute impact forces and resist bending when an impact force is applied to the computing device. Additionally, a bracket can be connected to a circuit board of the computing device to further help distribute impact forces and resist bending. The bracket can be ring shaped and surround components connected to the circuit board to intercept impact forces from contacting the components.

### FIELD

The described embodiments relate generally to mechanisms for reducing fractures of device components. More particularly, the present embodiments relate to structures that can be incorporated onto device components to counteract forces of impact against a computing device in which the device components are incorporated.

### BACKGROUND

Computing devices have become thinner and more compact as a result of many advances in technology. However, because thinner devices can be susceptible to bending, the components within the device often times become fractured as a result of high internal bending stresses caused by some external force impacting the device. These high in-plane stresses due to bending can be more critical than out-of-plane stresses resulting from impact. Although some devices may incorporate thicker housings or frames as solutions to counter bending and impact stresses, such solutions can necessitate additional materials that may reduce thermal efficiency of a device, increase cost of manufacturing the device, and limit the available space for internal components.

### SUMMARY

This paper describes various embodiments that relate to features of a computing device for reducing damage to internal components caused by bending stresses. In some embodiments, a computing device is set forth as having a circuit board and a component connected to the circuit board. The component can include a curved spacer disposed over a surface of the component to mitigate bending stresses at the component. Furthermore, the computing device can include a cover glass and a display assembly that are configured such that the surface of the component faces the display assembly and the cover glass.

In other embodiments, a circuit component is set forth. The circuit component can include processing circuitry and a surface that at least partially covers the processing circuitry. Additionally, the circuit component can include a spacer disposed over the surface of the circuit component to mitigate bending stresses from damaging the processing circuitry. The spacer can have a curved profile and span a width of the surface of the circuit component.

In yet other embodiments, a system is set forth. The system can include a first circuit assembly comprising a first surface connected to a first component, a second component, and a bracket surrounding the first component. The system can further include a second circuit assembly comprising a second surface connected to a spacer disposed between the second component and the second surface. The spacer can be arranged to contact the second component when the second surface is bent toward the first surface.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIGS. 1A-1C illustrate various views of a computing device according to some embodiments.

FIGS. 2A-2C illustrate various views of spacers that can be incorporated into a computing device.

FIGS. 3A-3C illustrate various views of a spacer that can be incorporated over a component of a computing device.

FIGS. 4A-4C illustrate various views of a flat spacer that can be incorporated onto a component or surface of a computing device.

FIGS. 5A-5C illustrate various views of a spacers that can be incorporated into a computing device.

FIGS. 6A-6C illustrate various views of brackets that can be incorporate into a computing device.

FIG. 7 illustrates a method for forming and connecting a spacer to a computing device.

FIG. 8 illustrates a method for forming and connecting a bracket to a computing device.

### DETAILED DESCRIPTION

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments disclosed herein related to systems, methods, and apparatuses for reducing impact stresses to certain device components when a device that incorporates the components receives some force from an impact against the device. The device can include a display, a housing, and one or more components connected to a circuit board between the display and the housing. The components can be connected on opposite sides of the circuit board and can include electrical components such as, but not limited to, a central processing unit (CPU), a graphics processing unit (GPU), a system on a chip (SOC), a power management unit (PMU), or any other component suitable for connecting to a circuit board. Because of the limited space within the device, when a force from an impact is received at the display or housing, the display or housing may bend into the circuit board, which can cause the components to also bend. Additionally, the impact can cause the components to be momentarily compressed, which can result in fractures on the components. In order to counteract the bends and stresses that can result from certain forces of impact, stress absorbing mechanisms can be incorporated onto the components and/or the logic board, as discussed herein.

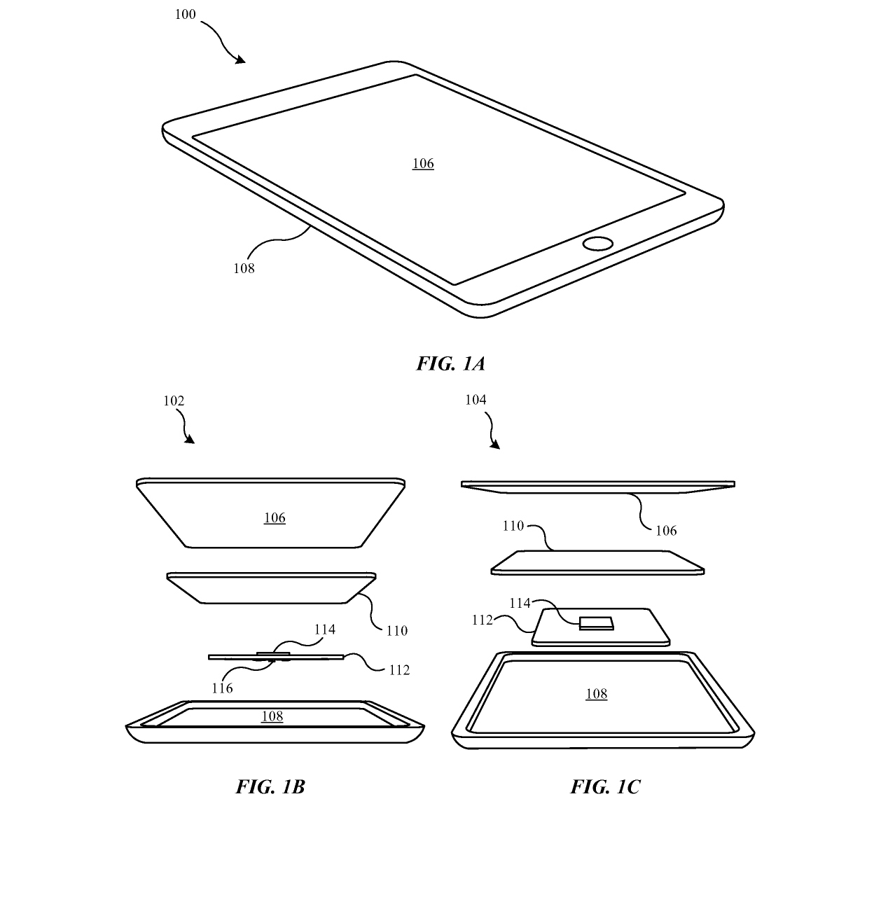

These and other embodiments are discussed below with reference to FIGS. 1A-8; however, those skilled in the art will readily appreciate that the detailed description given herein with respect to these figures is for explanatory purposes only and should not be construed as limiting.

FIG. 1A illustrates a computing device 100 that includes a cover glass 106 and a housing 108. The computing device 100 can include a variety of components such as a central processing unit (CPU), graphics processing unit (GPU), power management unit (PMU), system on a chip (SOC), and/or any other components suitable for performing computer related functions. When the computing device 100 is impacted by some external force, any one of the components can undergo some amount of stress. The stress can be caused by the cover glass 106 and/or the housing 108 projecting inward relative to the computing device 100, and bending or compressing the components. As a result, the components can experience fractures, which can cause the components to malfunction or otherwise become inoperable.

FIG. 1B illustrates an exploded view 102 of the computing device 100. Specifically, FIG. 1B illustrates an arrangement of the components between the cover glass 106 and the housing 108. For example, a component 114 can be connected to a circuit board 112 (e.g., a main logic board (MLB) or other circuit board assembly) such that a surface of the component 114 that opposes the circuit board 112 faces a display assembly 110. The component 114 can be a CPU, GPU, PMU, SOC, or any other circuit component that includes logic or processing circuitry. The display assembly 110 can include one or more layers of films, filters, display components, and/or any other devices suitable for assisting in certain functions of a display device. The display assembly 110 can correspond to a liquid crystal display (LCD), light emitting diode (LED) display, organic light emitting diode (OLED) display, and/or any other type of display device. Additional components 116 can be connected to a surface of the circuit board 112 that opposes the surface of the circuit board 112 on which the component 114 is connected. The components 116 can be disposed within a cavity of the housing 108, which can be made from any suitable housing material such as a metal or plastic, not limited to aluminum or steel. FIG. 1C illustrates another exploded view 104 of the computing device 100. As shown in FIG. 1C, the component 114 faces the display assembly 110 and cover glass 106 such that, when the either the housing 108 or the cover glass 106 receives some external force, the force can be transferred to the component 114. In order to mitigate harmful damage caused by external forces of impact, additional materials can be added to one or more parts of the computing device 100 as discussed herein.

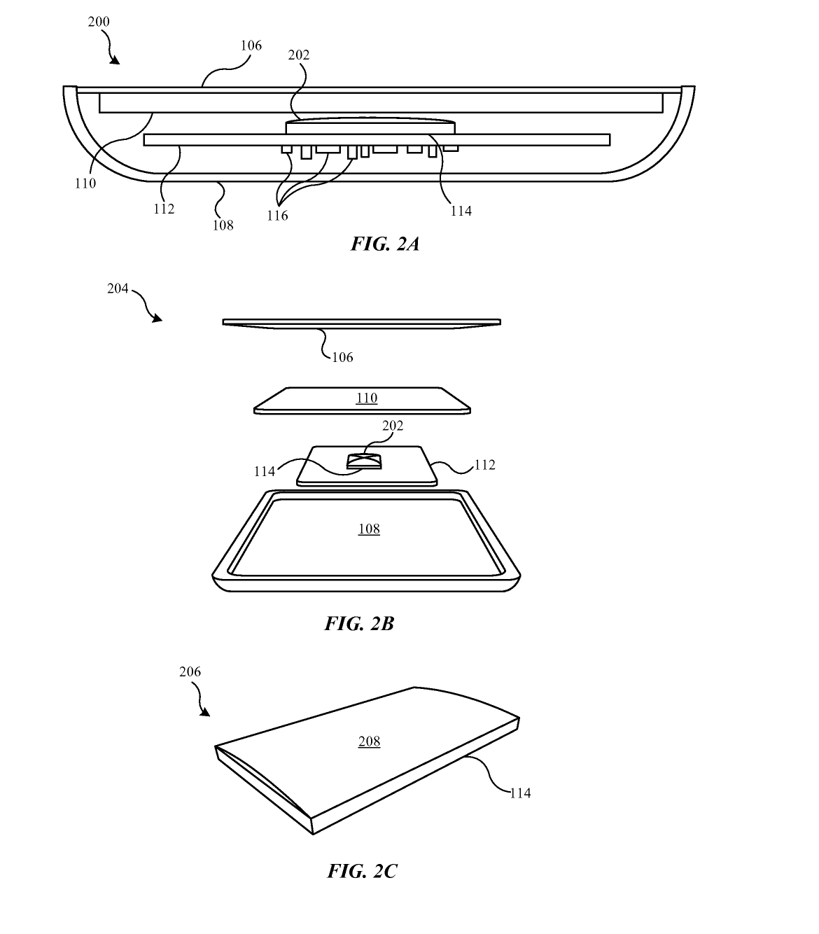

FIGS. 2A-2C illustrate various views of a spacer 202 that can be disposed over the component 114 according to some embodiments discussed herein. Specifically, FIG. 2A illustrates a cross-sectional view 200 of the computing device 100 with the spacer 202 disposed over the component 114. The spacer 202 can be made from any material not limited to a metal, plastic, epoxy, or any other material suitable for intercepting impact forces from being directly received by the component 114. The spacer 202 material can include particles that improve thermal conductivity of the spacer 202 material. For example, the spacer 202 material can include graphite and/or silicon particles. Additionally, the spacer 202 can be disposed fully or partially over a surface of the component 114. The spacer 202 can have a thickness that is greater than, equal to, or less than a thickness of the component 114. For example, in some embodiments, the thickness of the spacer 202 is less than or equal to 20% of the thickness of the component 114. As illustrated in FIG. 2A, the spacer 202 can have a curved profile. The curved profile of the spacer 202 can be defined by a radius that is derived through one or more computer simulations including Finite Element Analysis (FEA). The radius of the curvature will influence the ratio of bending (in-plane) to out-of-plane stresses. The simulations can provide feedback in response to simulated impact forces on a simulated computing device. In this way, designers are able to ensure that a radius of the spacer 202 will adequately distribute impact forces in a way that mitigates and prevents fractures from occurring at the component 114, and counteracts bending of the circuit board 112.

FIG. 2B illustrates an exploded view 204 of the computing device 100 incorporating the spacer 202. As shown in the FIG. 2B, the spacer 202 can extend over an entire surface of the component 114 that faces the cover glass 106 and display assembly 110. Additionally, the spacer 202 can be curved over the entire surface of the component 114. Moreover, the spacer 202 can extend over one or more edges of the surface of the component 114. In some embodiments, the spacer 202 can have one or more planar surfaces facing the cover glass 106 and display assembly 110, or perpendicular to the cover glass 106 and the display assembly 110. The spacer 202 can be shaped like a dome such that all sides of the spacer 202 terminate at a slope relative to the component 114. The spacer 202 can also be shaped to have a sloped profile where less than all sides of the spacer 202 terminate at a slope relative to the component 114, as illustrated in the perspective view 206 of FIG. 2C. Specifically, FIG. 2C illustrates a spacer 208 having at least one edge that terminates in an acute or obtuse angle relative to the component 114, and at least one edge that terminates at an orthogonal angle relative to the component 114.

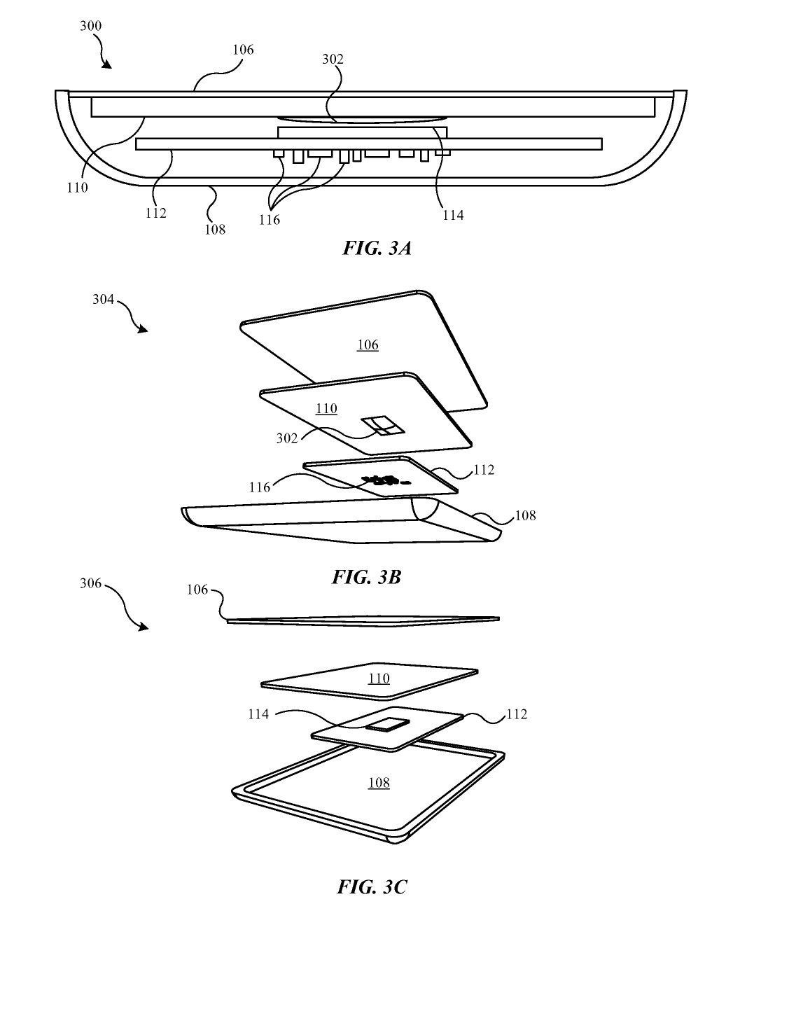

FIGS. 3A-3C illustrate various views of a spacer 302 that can be disposed over a surface of the computing device 100 that opposes the component 114 according to some embodiments discussed herein. Specifically, FIG. 3A illustrates a cross-sectional view 300 of the computing device 100 with the spacer 302 disposed over a display assembly 110 or other circuit assembly. The spacer 302 can be formed according to any of the embodiments discussed. For example, the spacer 302 can be made from a metal, a plastic, an epoxy, or any other material suitable for intercepting impact forces from being directly received by the component 114. Additionally, the spacer 302 can be disposed over an area of the display assembly that is greater than, less than, or equal to an area of a surface of the component 114. Moreover, the spacer 302 can have a thickness that is greater than, less than, or equal to a thickness of the component 114. As illustrated in FIG. 3A, the spacer 302 can have a curved profile, which can have a radius that is derived through one or more computer simulations for optimizing the ability of the spacer 302 to distribute impact forces.

FIG. 3B illustrates an exploded view 304 of the computing device 100 incorporating the spacer 302. As shown in FIG. 3B, the spacer 302 can be curved, however, in other embodiments the spacer 302 can have a flat profile. Furthermore, the spacer 302 can be dome shaped such that all sides of the spacer 302 terminate at a slope relative to the display assembly 110. In some embodiments, the spacer 302 can have a sloped profile where less than all sides of the spacer 302 terminate at a slope relative to the display assembly 110. FIG. 3C illustrates an exploded view 306 of the computing device 100 with the spacer 302. Specifically, FIG. 3C illustrates a position of the component 114 below the spacer 302, such that impact forces received at the housing 108 and/or the cover glass 106 can cause the spacer 302 to counter bending of the display assembly 110, circuit board 112, and/or component 114. Conversely, the spacer 302 can also superimpose bending of the component 114 in the opposite direction, should an impact occur at a backside of the housing 108, opposite the cover glass 106.

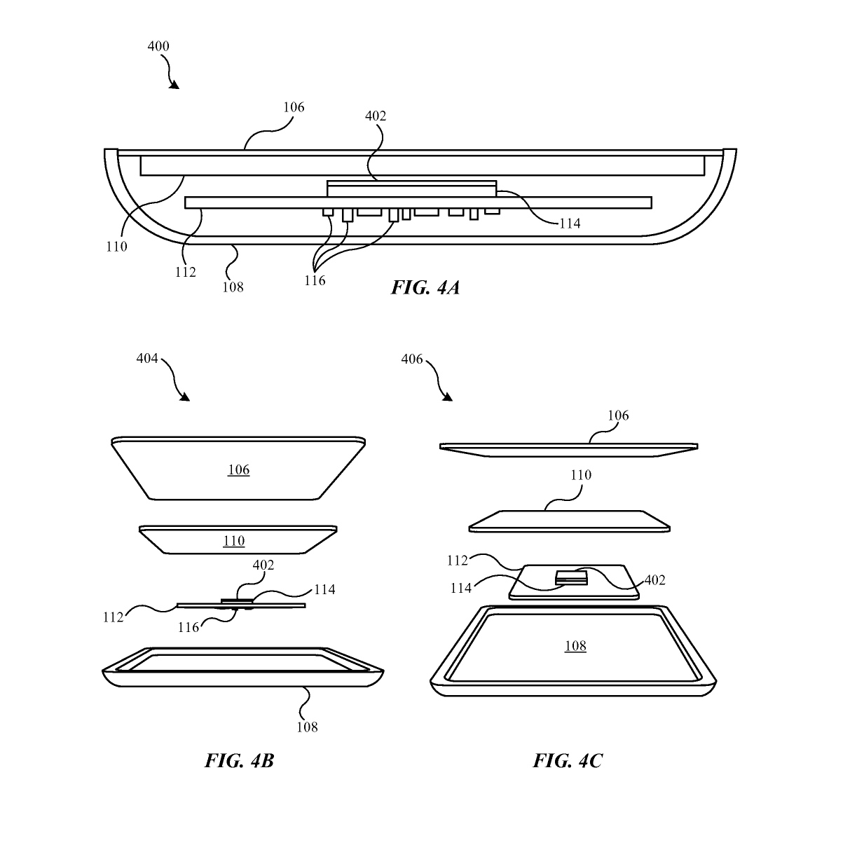

FIGS. 4A-4C illustrate various views of a spacer 402 with a flat profile and that can be disposed over the component 114 or a circuit board according to some embodiments discussed herein. Specifically, FIG. 4A illustrates a cross-sectional view 400 of the computing device 100 with the spacer 402 disposed over the component 114. The spacer 402 can be formed according to any of the embodiments discussed herein, and can include any of the materials discussed herein. The spacer 402 can have a flat profile such that a surface of the spacer 402 that opposes the component 114 is parallel to a surface of the component 114. The spacer 402 can be disposed fully or partially over a surface of the component 114. Additionally, the spacer 402 can have a thickness that is greater than, equal to, or less than a thickness of the component 114. For example, in some embodiments, the thickness of the spacer 402 is less than or equal to 20% of the thickness of the component 114. The spacer 402 can effectively distribute impact forces away from the component 114 and counteract bending of the circuit board 112.

FIG. 4B illustrates an exploded view 404 of the computing device 100 incorporating the spacer 402. As shown in FIG. 4B, the spacer 402 extends over an entire surface of the component 114 that faces the cover glass 106 and the display assembly 110. Additionally, the spacer 402 is flat over the entire surface of the component 114. However, in some embodiments, the spacer 402 can have one or more curved surfaces faces the cover glass 106 and the display assembly 110. The spacer 402 can not only mitigate bending of the component 114 but also mitigate bending of the circuit board 112. FIG. 4C illustrates an exploded view of the component 114 with the spacer 402 disposed over a surface of the component 114. It should be noted that although the spacer 402, or any of the spacers discussed herein, is illustrated on the circuit board 112, the spacers can also be disposed on the housing 108, the circuit board 112, the display assembly 110, the cover glass 106, or any other surface of the computing device 100. Additionally, multiple spacers can be disposed on one or more surfaces of the computing device 100 in order to protect certain components of the computing device 100 from damage cause by compression and tension.

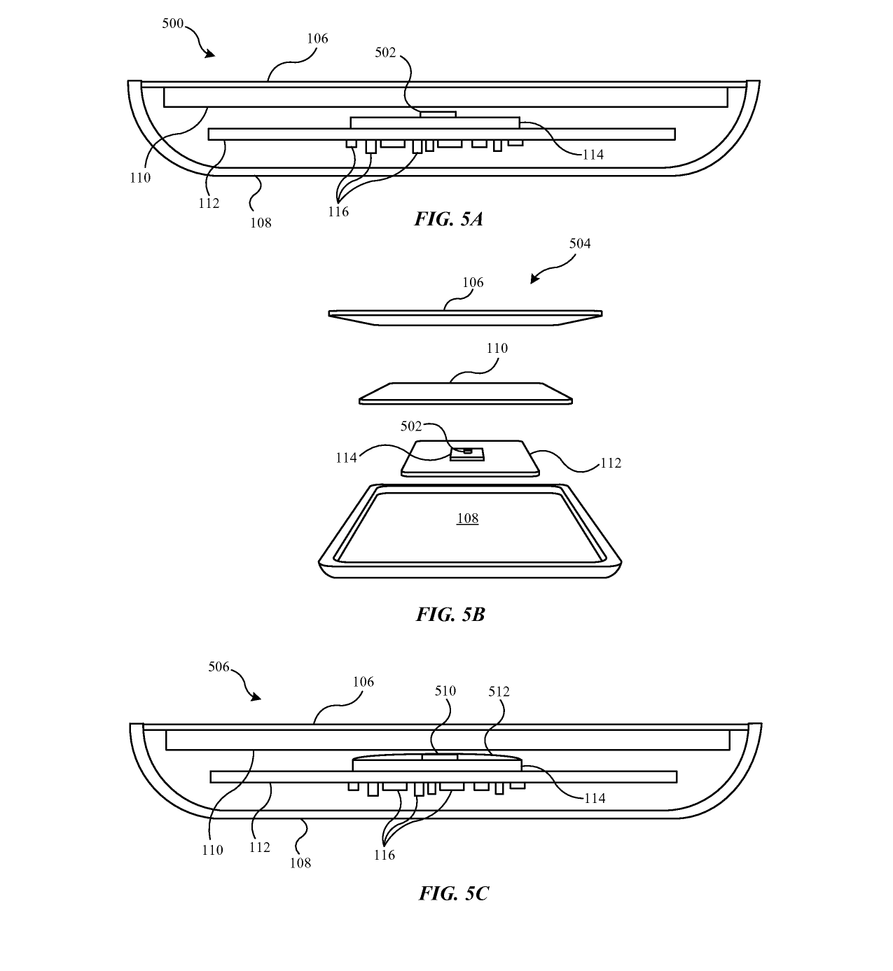

FIGS. 5A-5C illustrates various views of a spacer 502 that can be disposed over the component 114 or any other surface of the computing device 100 as discussed herein. Specifically, FIG. 5A illustrates a cross-sectional view 500 of the computing device 100 with the spacer 502 disposed over the component 114. The spacer 502 can have a cross section that can resemble a circle, an oval, a polygon, or any other shape suitable for intercepting impact forces from being directly received by the component 114. Additionally, the spacer 502 can be made from any material discussed herein, not limited to metal, plastic, epoxy, or a material infused with thermally conductive particles such as graphite and silicon. Furthermore, the height of the spacer 502 relative to the component 114 can be equal to, greater than, or less than a thickness of the component 114. Moreover, a profile of a top surface of the spacer 502 can be flat or curved in some embodiments. FIG. 5B illustrates an exploded view 504 of the computing device 100 with the spacer 502 disposed over a surface of the component 114. Although the spacer 502 is arranged at the center of a surface of the component 114, the spacer 502 can also be offset from a surface of the component 114. Moreover, the spacer 502 can also be connected to the circuit board 112 and extend toward the display assembly 110, or connect to the display assembly 110 and extend toward the circuit board 112. In some embodiments, the spacer 502 is connected to the housing 108 between the circuit board 112 and the housing 108, between the display assembly 110 and the housing 108, and/or between the cover glass 106 and the housing 108.

FIG. 5C illustrates an embodiment of a combination spacer that can be disposed over a surface of the computing device 100. Specifically, FIG. 5C illustrates a cross-sectional view 506 of the computing device 100 with a first spacer 510 and a second spacer 512 disposed around or adjacent to the first spacer 510. The first spacer 510 can be a column shaped spacer that extends from a surface of the component 114. The second spacer 512 can be a sloped spacer that is disposed between an edge of the component 114 and the first spacer 510. In some embodiments, the first spacer 510 can have a flat profile or a curved profile. Furthermore, the first spacer 510 and the second spacer 512 can be made from the same or different materials. In some embodiments, a height of the first spacer 510 relative to the component 114 can be greater than or less than a height of the second spacer 512. Additionally, the first spacer 510 can be disposed over a center of the component 114 or offset from the center of the component 114. In some embodiments, more than two spacers can be disposed over the component 114.

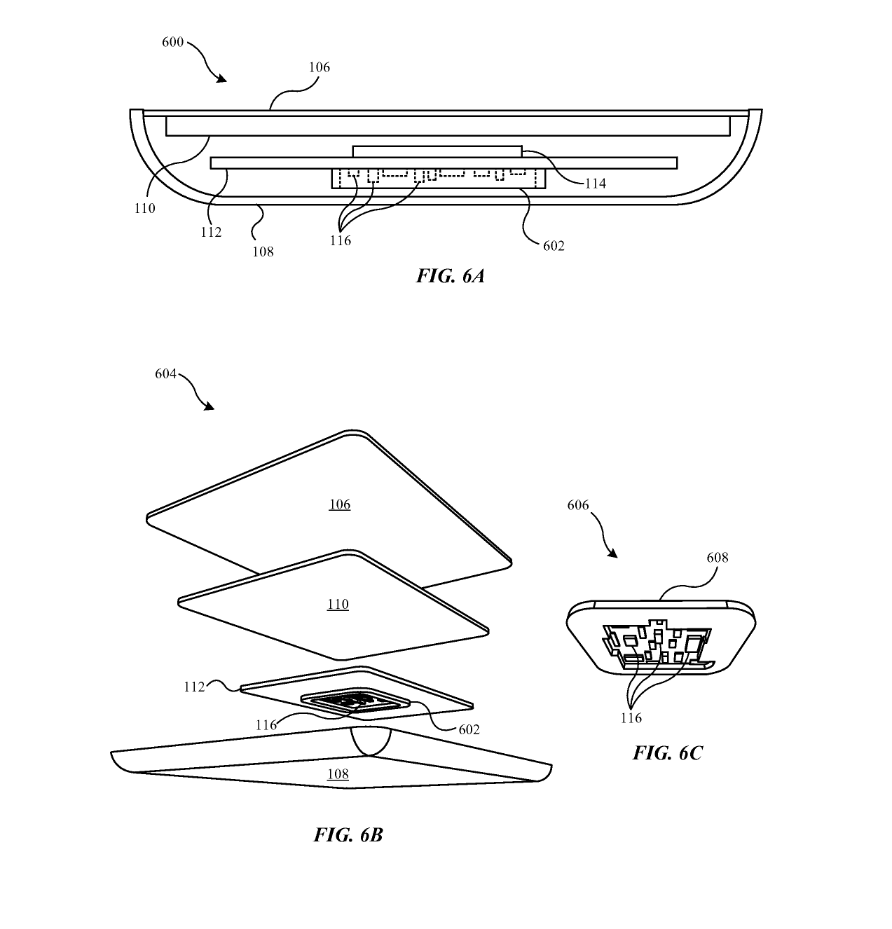

FIGS. 6A and 6B illustrate various views of a bracket 602 that can be disposed over the component 114, or any other surface within the computing device 100, according to some embodiments discussed herein. Specifically, FIG. 6A illustrates a cross-sectional view 600 of the computing device 100 with the bracket 602 disposed around the components 116 that are connected to the circuit board 112. The components 116 are shown as dotted lines to indicate that the components 116 are behind a surface of the bracket 602. The bracket 602 can be made from a metal, a plastic, or any material suitable for creating a barrier that will intercept impact forces that are received by the circuit board 112 and the components 116. For example, the bracket 602 can be made from a metal alloy such as steel in order to provide a rigid boundary around the components 116. As illustrated in FIG. 6A, the bracket 602 can be disposed over a surface of the circuit board 112 that faces the housing 108. In other embodiments, the bracket 602 can be connected to the housing 108, the display assembly 110, the cover glass 106, or any other surface of the computing device 100. Furthermore, multiple brackets 602 can be connected to the computing device 100 to mitigate damage to parts of the computing device 100 as a result of impact forces against the computing device 100.

FIG. 6B illustrates an exploded view 604 of the bracket 602 that can be connected to the circuit board 112 and arranged to surround the components 116. A thickness of the bracket 602 can be equal to or greater than a length at which a component 116 extends from the circuit board 112. In some embodiments, the thickness of the bracket 602 can be less than a length at which a component 116 extends from the circuit board 112 in order for the bracket 602 to resist bending of the circuit board 112. In some embodiments, the bracket 602 can extend closer to the components 116 in order to maximize surface area of the bracket 602 between the housing 108 and the circuit board 112, as illustrated in FIG. 6C. Specifically, FIG. 6C illustrates a perspective view of an embodiment of a bracket 608 that can be connected to the circuit board 112 in order to mitigate stress and tension on the components 116. The bracket 608 can include one or more inner walls that extend around a portion of one or more components 116. In this way, the outer perimeter of the bracket 608 can be reduced while increasing a surface area of bracket 608. It should be noted that any of the embodiments of the spacer and bracket discussed herein can be combined in any manner suitable for mitigating damage to computing device components caused by stress or tension. For example, in some embodiments, the bracket 602 can be incorporated on the circuit board 112 and the spacer 202 can be incorporated on the component 114 or on any other surface of the computing device 100.

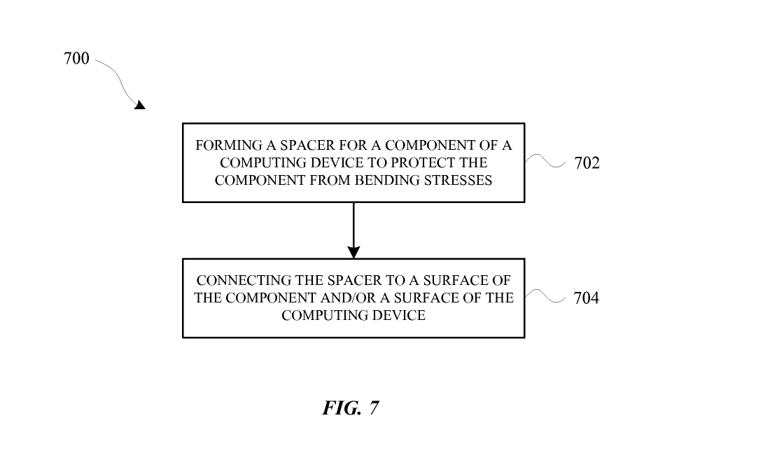

FIG. 7 illustrates a method 700 for connecting a spacer to a computing device to protect components of the computing device from bending stresses. The method 700 can be performed by any computing device, apparatus, or manufacturing device suitable for connecting components. The method 700 can include a step 702 of forming a spacer for a component of a computing device to protect the component from bending stress. The spacer can be any of the spacers discussed with respect to FIGS. 1A-6C. Additionally, the computing device can be any device that includes components, including computing device 100 discussed herein. The method 700 can further include a step 704 of connecting the spacer to a surface of the component and/or a surface of the computing device. In this way, the spacer can mitigate bending stresses at the component.

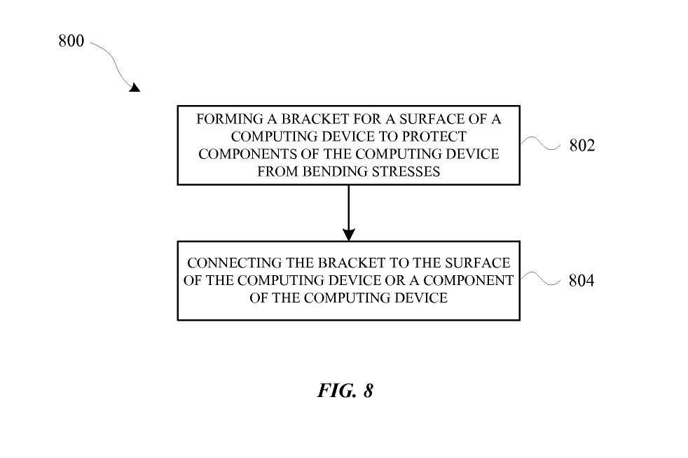

FIG. 8 illustrates a method 800 for connecting a bracket to a surface of a computing device to protect components of the computing device from bending stress. The method 800 can be performed by any computing device, apparatus, or manufacturing device suitable for connecting components. The method 800 can include a step 802 of forming a bracket for a surface of a computing device to protect components of the computing device from bending stresses. The bracket can be any bracket discussed herein, such as the bracket 602 or bracket 608 of FIGS. 6A and 6B, and FIG. 6C respectively. The method 800 can further include a step 804 of connecting the bracket to the surface of the computing device or a component of the computing device. In this way, the bracket can mitigate bending stresses across the surface of the computing device.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A computing device, comprising:
a circuit board; and
a component connected to the circuit board, wherein the component includes a curved spacer disposed over a surface of the component for mitigating bending stresses at the component.

2. The computing device of claim 1, further comprising:
a cover glass; and
a display assembly, wherein the surface of the component faces the display assembly and the cover glass.

3. The computing device of claim 1, wherein a first thickness of the curved spacer is less than a second thickness of the component.

4. The computing device of claim 1, wherein the curved spacer covers an entire area of the surface of the component.

5. The computing device of claim 1, wherein the component is one of a central processing unit, a graphics processing unit, a power management unit, or a system on a chip.

6. The computing device of claim 1, further comprising:
a bracket connected to the circuit board on a first side of the circuit board, wherein the component is connected to a second side of the circuit board.

7. The computing device of claim 6, wherein the bracket surrounds one or more components of the circuit board on the first side of the circuit board.

8. A circuit component comprising:
processing circuitry;
a surface that at least partially covers the processing circuitry; and
a spacer disposed over the surface of the circuit component for preventing bending stresses from damaging the processing circuitry.

9. The circuit component of claim 8, wherein the spacer includes a curved profile.

10. The circuit component of claim 9, wherein the spacer spans a width of the surface of the circuit component.

11. The circuit component of claim 8, wherein the spacer is made from injection molded metal, an injection molded plastic, or an epoxy.

12. The circuit component of claim 8, wherein a thickness of the spacer is less than half of an entire thickness of the circuit component.

13. The circuit component of claim 8, wherein the spacer is made from an epoxy that is infused with particles to increase thermal conductivity of the epoxy.

14. A system comprising:
a first circuit assembly comprising a first surface connected to a first component, a second component, and a bracket surrounding the first component; and
a second circuit assembly comprising a second surface connected to a spacer disposed between the second component and the second surface.

15. The system of claim 14, wherein the spacer is configured to contact the second component when the second surface is bent toward the first surface.

16. The system of claim 14, wherein the spacer includes a curved convex profile relative to the second surface.

17. The system of claim 14, wherein a first thickness of the bracket is greater than a second thickness of the first component.

18. The system of claim 14, wherein the first component and the second component are connected to different sides of the first surface.

19. The system of claim 14, wherein the second component is a processor that is thicker than the spacer.

20. The system of claim 14, wherein at least one of the bracket and the spacer is made from a metal alloy.
